(19) United States
(12) Patent Application Publication
(10) Pub. No.: US 2015/0209750 A1
(43) Pub. Date: Jul. 30, 2015

(54) METHOD FOR PREPARING A SLURRY OF PULVERIZED SOLID MATERIAL IN LIQUID OR SUPERCRITICAL CARBON DIOXIDE

(71) Applicants: Cristina Botero, Boston, MA (US); Randall Perkins Field, Andover, MA (US); Howard J. Herzog, Belmont, MA (US); Ahmed F. Ghoniem, Winchester, MA (US)

(72) Inventors: Cristina Botero, Boston, MA (US); Randall Perkins Field, Andover, MA (US); Howard J. Herzog, Belmont, MA (US); Ahmed F. Ghoniem, Winchester, MA (US)

(73) Assignee: Massachusetts Institute of Technology, Cambridge, MA (US)

(21) Appl. No.: 14/682,408

(22) Filed: Apr. 9, 2015

Related U.S. Application Data
(63) Continuation of application No. PCT/US2013/064056, filed on Oct. 9, 2013.
(60) Provisional application No. 61/712,954, filed on Oct. 12, 2012.
(60) Provisional application No. 61/829,321, filed on May 31, 2013.

(51) Int. Cl. B01J 13/00

(52) U.S. Cl. CPC B01J 13/00

(57) ABSTRACT

Method for making a slurry of a pulverized solid in liquid or supercritical carbon dioxide. The method includes making a water-pulverized solid slurry at ambient pressure and pressurizing the water-pulverized solid slurry to a high pressure. The pressurized water-pulverized solid slurry is mixed in a pressurized chamber with liquid or supercritical CO₂ to form a CO₂-pulverized solid slurry.

### PRIORITY INFORMATION

This application claims priority to utility application Ser. No. 14/048,150, filed on Oct. 8, 2013, provisional application Ser. No. 61/712,954 filed on Oct. 12, 2012, and to provisional application Ser. No. 61/829,321 filed on May 31, 2013, the contents of all of which are incorporated herein by reference.

### BACKGROUND OF THE INVENTION

This invention relates to slurries and more particularly to a method for producing a suspension or slurry of pulverized solid material, such as coal, in liquid or supercritical carbon dioxide. The invention also relates to preparing a dense, high pressure state via phase inversion with carbon dioxide.

The continuous conveying of a solid feedstock such as pulverized coal (PC) into a pressurized vessel is a challenging step that is required in multiple processes such as gasification, combustion, etc. Commercial technologies for continuous PC conveying are classified as slurry or as dry feeding systems.

Dry feeding systems often use lock hoppers to feed coal in its dense phase with the help of a transport gas. Such systems operate on the principle of intermittent feeding across the pressure boundary, typically by the staged opening and closing of valves on the top and bottom of a charged pressure vessel called a lock hopper. The top valve opens to receive material while the bottom valve is closed. The top valve is then closed and the lock hopper is brought to or above system pressure through injection of a gas such as nitrogen. Once the hopper is pressurized, the bottom valve is opened and the material discharged to the desired process. Often, dual or parallel lock hoppers are used [1].

Dry feeding systems are very efficient but are less reliable mainly as a result of poor valve operation in a dusty environment. Dry feeding systems also cost about three times as much as slurry fed systems [2] and usually require feedstock drying to yield a free flowing solid. Further, lock hopper-based dry feeding systems have a range of application limited to below 30 bar, above which the amount of transport gas required makes the process highly inefficient [3].

In slurry feeding systems, the solid feedstock is first suspended in a liquid medium such as water. The suspension, or slurry, can then be pumped to a desired pressure. Commercial systems for pulverized coal slurry feeding use water as the slurrying medium. Other liquid slurrying media such as oil and liquid carbon dioxide have also been suggested [4].

Slurry feeding systems are significantly cheaper and more reliable and can achieve higher pressures of 200 bar and beyond [3]. However, injection of water into this process makes the system very inefficient. The water must usually be brought to high process temperatures which requires a large energy investment given its high heat capacity and enthalpy of vaporization [5].

Other types of solid feeding systems such as rotary feeders, plug-forming and non-plug-forming feeders are also known. However, their range of applicability is limited both in terms of the pressure and of the mass flows that they can handle [6]. Alternative feeding systems such as dry solids pumps are currently under development [7, 8].

The use of liquid carbon dioxide as a coal slurrying medium has been suggested in the past both in the context of pipeline transportation of coal slurry and for feeding coal into pressurized processes [10]. The low heat capacity, vaporization enthalpy, and viscosity of liquid CO₂ make it an attractive alternative to water as a slurrying meeting. In addition, liquid CO₂ is readily available from the CO₂ compression unit of plants with carbon capture.

Previous studies have estimated that the efficiency advantage of a plant with coal-CO₂ slurry is very significant. For example, an integrated gasification combined cycle (IGCC) power plant with coal-CO₂ slurry is estimated to be up to 25% more efficient than a plant based on a coal-water slurry [5]. This increased efficiency is particularly true for abundant low-rank coal whose utilization is otherwise very inefficient, making the current feeding system very attractive.

Unlike coal-water slurry, however, coal-CO₂ slurry cannot be prepared at ambient pressure: the triple point pressure of CO₂ is five bar so CO₂ will never exist in its liquid state at lower pressures including ambient pressure. The method for mixing coal and liquid CO₂ into a pressurized slurry is hence a key aspect of the coal-CO₂ slurry process since the coal available for slurry preparation is at ambient conditions and must be mixed with CO₂ at high pressure.

The use of coal-CO₂ slurry is known in the prior art. U.S. Pat. No. 3,976,443 discloses the use of a coal-CO₂ slurry as a way to feed coal into a pressurized gasifier. U.S. Pat. Nos. 4,206,610 and 4,765,781 target the transport of coal through a pipeline in the form of a slurry. All three of these patents describe the method for preparing coal-CO₂ slurry that includes pressurization of coal in a lock hopper first, typically with gaseous CO₂, followed by mixing with pressurized liquid carbon dioxide at temperatures above 0° C. Preparation of a coal-CO₂ slurry at a lower temperature of 23° C. is discussed by Dooher et. al [11]. Dooher et. al implies the use of lock hoppers to pressurize the coal first. Coal drying prior to slurry preparation is often suggested in the proposed processes [2, 11, 12].

U.S. Pat. No. 4,613,429 presents a method for removing mineral matter from coal by employing liquid CO₂. In the disclosed process, coal-water slurry is thoroughly mixed with CO₂ in a pressurized, liquid contacting vessel. Two distinct phases are formed and can be separated. Significantly, this patent does not teach making a water-coal slurry at ambient pressure nor does it teach or suggest pressurizing the coal/water feed slurry to high pressure before introduction into a chamber for contact with CO₂. This patent likely requires a lock hopper to pressurize the feed coal.

It is therefore an object of the present invention to provide a method for preparing a slurry of pulverized solid material in liquid or supercritical carbon dioxide using a coal water slurry prepared at ambient pressure and then pumped to a high pressure for contact with the carbon dioxide followed by introduction into a desired process. A further object is a process that requires neither coal drying nor the use of lock hoppers. The present invention takes advantage of a physical phenomenon known as phase-inversion, by which hydrophobic coal surfaces are preferentially wetted by CO₂, rather than by water. Coal is used herein as an exemplary pulverized solid material. The process disclosed herein is applicable to any other solid material such as petcoke, biomass, etc.

### SUMMARY OF THE INVENTION

The method according to the invention for making a slurry of a pulverized solid in liquid or supercritical carbon dioxide includes making a water-pulverized solid slurry at ambient pressure and then pressurizing the water-pulverized solid slurry. The pressurized water-pulverized solid slurry is then mixed in a pressurized chamber with liquid or supercritical CO₂ to form a CO₂-pulverized solid slurry. A preferred embodiment further includes vaporizing excess CO₂ from the CO₂-pulverized solid slurry to concentrate the CO₂-pulverized solid slurry. In a preferred embodiment, the water-pulverized solid slurry is pressurized in the range of 60-80 bar. The carbon dioxide may be vaporized to provide an 80% loading.

In yet another embodiment, the method includes slurry skimming to remove substantially all of the CO₂ from the CO₂-pulverized solid slurry. The slurry skimming step may involve low-grade heat addition and/or a pressure reduction.

### BRIEF DESCRIPTION OF THE DRAWING

FIG. 1 is a schematic illustration of an embodiment of the method disclosed herein.

FIG. 2 is a schematic illustration of production of CO₂ slurry via phase inversion followed by full CO₂ skimming to produce a dense solid phase at high pressure.

FIG. 3a is a schematic of the slurry skimming step for a preferred embodiment of the invention.

FIG. 3b is a graph of CO₂ pressure versus enthalpy for corresponding states.

FIG. 4 is a schematic illustration of slurry skimming through indirect heat exchange with hot/warm fluid such as water according to an embodiment of the invention.

FIG. 5 is a schematic illustration of slurry skimming through direct heat exchange with hot CO₂ according to an embodiment of the invention.

### DESCRIPTION OF THE PREFERRED EMBODIMENT

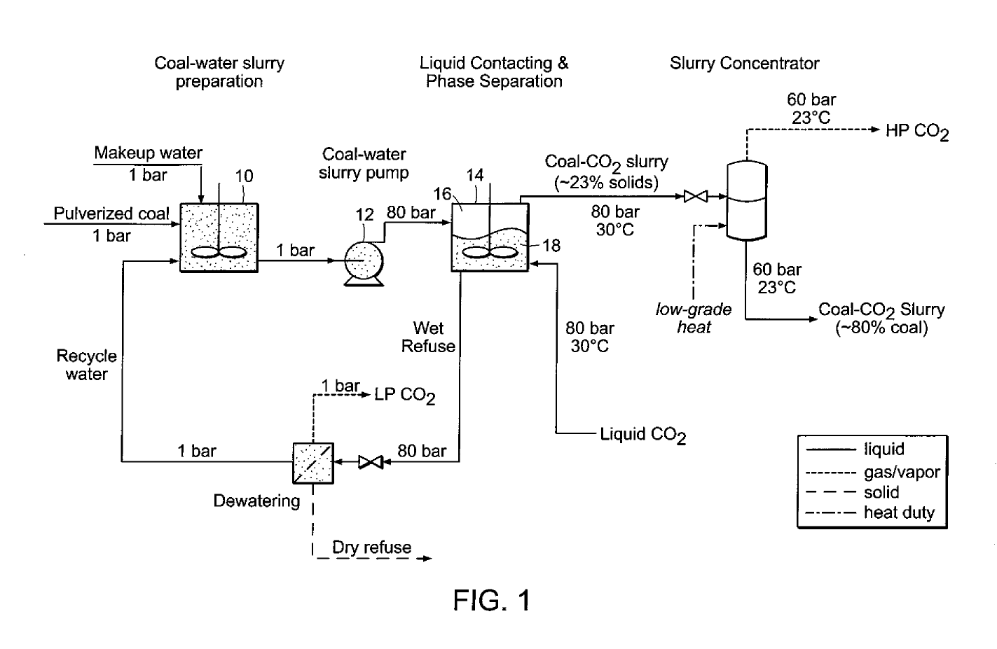

Coal-water slurry (CWS) is prepared from pulverized coal and water at ambient pressure and near ambient temperature in a slurry mixing tank 10 as shown in FIG. 1. Coal drying can be carried out prior to slurry preparation but is not required. The loading of coal in the CWS is typically 20%, by weight, including coal moisture. The CWS is pumped to a high pressure, typically 60-80 bar, by a pump 12 and mixed with liquid CO₂ in a pressurized vessel 14 at near ambient temperature. The residence time in the mixing vessel 14 is about five minutes and the mass flow rate of CO₂ is typically half that of the coal-water slurry. One or more pre-mixing stages may be used as has been observed to be beneficial to the process performance [7].

Two distinct phases form in the mixing vessel 14 under the operating conditions of the present invention which can be separated in the same or a separate vessel: a light, CO₂-rich phase 16 is collected from the top of the vessel 14 and a heavy aqueous phase 18 from the bottom of the vessel. Coal particles preferentially accumulate in the CO₂ phase, forming a coal-CO₂ slurry. Ash particles, on the other hand, tend to accumulate in the heavier aqueous phase 18. Surface properties of the coal being used and the process operating conditions determine the coal and ash recovery in each phase.

The high-ash solids collected in the aqueous phase 18 are dewatered at ambient pressure and disposed of. Any kind of solid-liquid separation equipment such as a cyclone, moving screens, filters, etc., can be used for this purpose. CO₂ desorbed from the aqueous phase as a result of the pressure reduction is flared or recompressed back to liquid CO₂ and the separated water is recirculated back to the CWS preparation tank 10. The coal-CO₂ slurry collected from the top of the mixing vessel 14 is at high pressure and ambient temperature. The coal's moisture content is typically 5-10%, by weight, but can be as low as 0% and as high as its as received moisture, depending on process conditions.

The CO₂-coal slurry can be directly fed to a high pressure process such as a high-pressure gasifier (not shown). However, because the coal-CO₂ slurry typically has a coal loading of only about 25%, a slurry concentration step may be required. This step can be carried out by vaporizing excess CO₂ through pressure reduction and/or low-grade heat addition. A precise strategy depends on the slurry overpressure and the loading required. Loading of 80% is typical for adequate slurry flow properties; however, a loading of close to 100%, i.e., a dry coal stream, can also be produced by evaporating the entire CO₂ content in the slurry. The gaseous CO₂ stream released in the concentration step can be flared or recompressed back to liquid CO₂. The CO₂ slurry can be pumped to a higher pressure before or after the concentration step if required.

While not being held to any particular theory, the accumulation of coal in the CO₂ phase is believed to be a physical, surface-property-driven phenomenon by which water is displaced from the coal as a result of the preferential wetting of the hydrophobic coal surface by CO₂. The exact mechanism of this process, also known as phase-inversion, is not well understood at the present time [15, 16]. Extensive experimental work conducted in the past has demonstrated this phenomenon, whereas coal recoveries of up to 90% in the CO₂ slurry and the ash separation efficiency of up to 95% have been observed. The low moisture (5-10%) in the recovered coal has been identified to be one of the largest appeals of the process disclosed herein.

Those of skill in this art will recognize that the coal, ash and moisture content of the CO₂ slurry obtained using the present invention depends on the interaction among the interfacial, sheer, and body forces present in the coal-CO₂—H₂O system and hence on the characteristics of the feedstock and on the operating conditions of the mixing process [14, 16].

In another aspect, the invention is a method for producing a pressurized, dense stream of pulverized, solid material such as coal that is achieved by flashing, or skimming, the CO₂ content out of pressurized coal-CO₂ slurry prepared as discussed above.

Despite the thermodynamic appeal of liquid CO₂ in the feeding system, recent work has shown that the presence of CO₂ in the feed could negatively impact the chemistry and thus the performance of downstream units. For a high-pressure gasifier with bituminous coal-CO₂ slurry feed, for example, a significant conversion reduction is predicted in a reactor when water is substituted by CO₂ as the slurrying medium. Once this is accounted for, no performance advantage is predicted relative to conventional coal-water slurry feed [6, 10]. To avoid potential challenges associated with the presence of CO₂ in the feed, the flow of the latter can be reduced by flashing, or evaporating, it from the pressurized coal-CO₂ slurry prior to injection into a reactor. If the entire content of the CO₂ in the slurry is evaporated, a dense solid stream at pressure results, which can be used to feed any high pressure process.

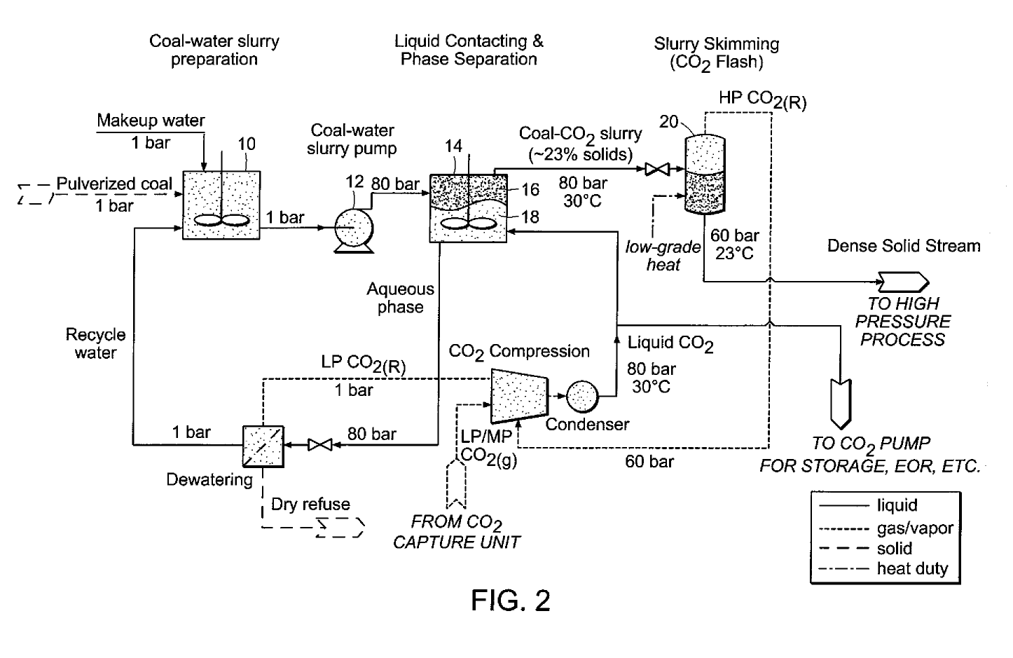

A schematic illustration of this aspect of the invention is shown in FIG. 2. A slurry skimming section 20 removes the entire CO₂ content of the slurry resulting in a dense solid phase stream of material.

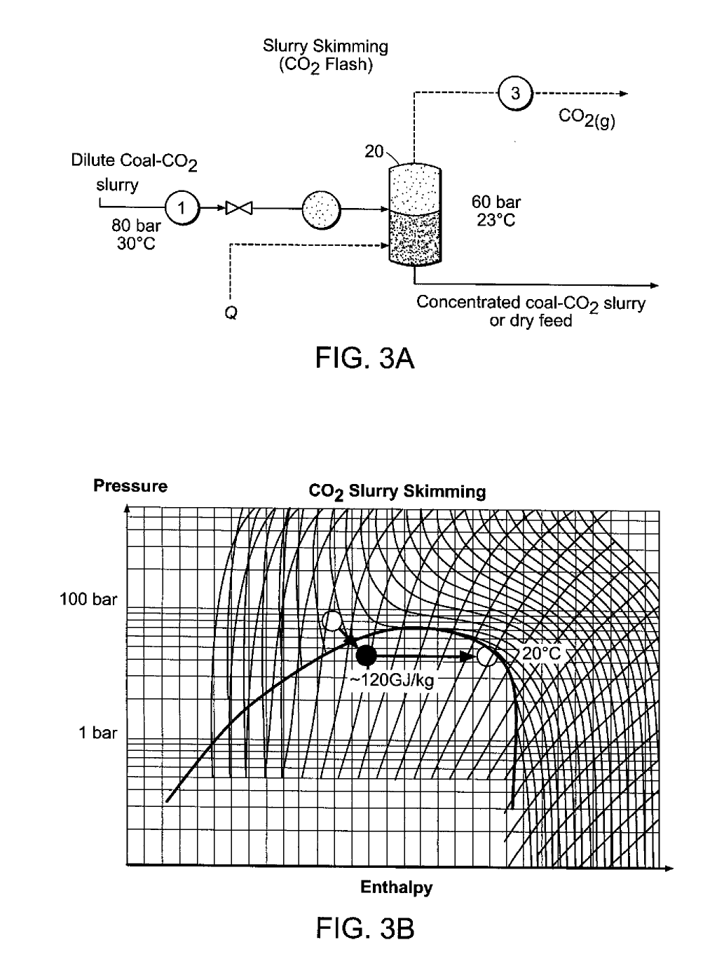

The removal of CO₂ from coal-CO₂ slurry can be easily achieved thanks to the proximity of CO₂ to its saturation line. As shown in FIG. 3a, showing typical operating conditions, slurry skimming can be carried out through a combination of modest pressure reduction and low-grade heat addition. Heat addition alone is sufficient if a pressure reduction is not desired. The final slurry loading can be as high as 100% but can be adjusted, as required, through the amount of heat added in the skimming unit. FIG. 3b shows pressure against enthalpy for the system.

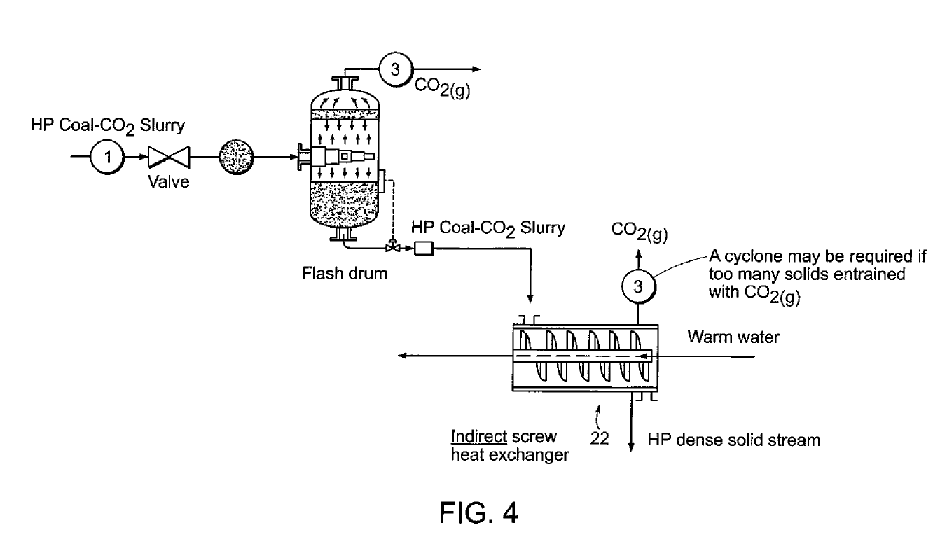

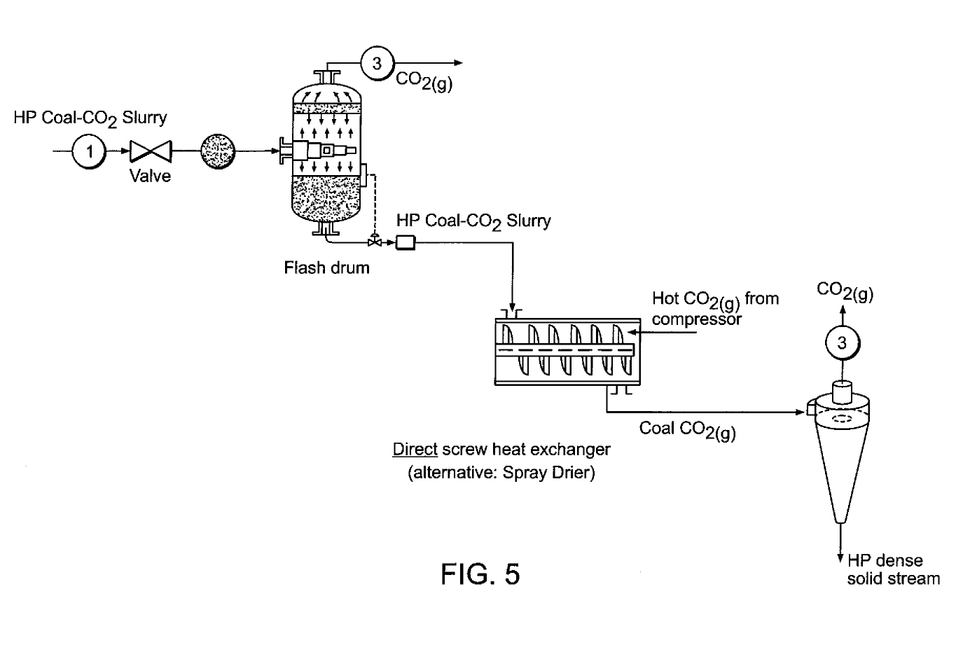

The low-grade heat addition required for CO₂ slurry skimming can be added through direct or indirect heat exchange with a heating medium. The process configuration and the type of equipment that can be used in each case are illustrated schematically in FIGS. 4 and 5, respectively.

Equipment such as a screw-type heat exchanger shown in FIG. 4 can be used for slurry skimming through indirect heat exchange with a warm fluid such as, but not limited to, water. A cyclone may be required to separate any entrained solids from the evaporated CO₂ stream. The dense solid stream can be fed to any high-pressure process.

Alternatively, heat addition can be carried out through direct heat exchange by using a similar piece of equipment but putting the slurry in direct contact with the heating medium. Hot, high-pressure CO₂ from the CO₂ compression unit can but used for this purpose as shown in FIG. 5. Other kinds of equipment such as a spray dryer can be used. The solid and gas phases are separated in a cyclone, producing a dense, solid stream at high pressure.

It is recognized that modifications and variations of the present invention are included within the scope of the appended claims.

The numbers in square brackets refer to the references listed herewith, the contents of all of which are incorporated herein by reference.

### REFERENCES

1. Swanson, M. et al., Feed System Innovation for Gasification of Locally Economical Alternative Fuels (FIGLEAF). Final Report, 2002
2. National Energy Technology Laboratory (NETL), Cost and Performance Baseline for Fossil Energy Plants, Volume 1: Bituminous Coal and Natural Gas to Electricity, Revision 2; DOE/NETL-2010/1397; 2010
3. Higman, C.; van der Burgt, M., Gasification. Second ed.; Elsevier: 2008.
4. Santhanam, C. J.; Dale, S. E.; Nadkarni, R. M. In Non-water Slurry Pipelines—Potential Techniques, 5th International Technical Conference on Slurry Transportation, Lake Tahoe, Nev. (USA), Lake Tahoe, Nev. (USA), 1980.
5. Botero, C.; Field, R. P.; Brasington, R. D.; Herzog, H. J.; Ghoniem, A. F., Performance of an IGCC Plant with Carbon Capture and Coai-CO₂-Slurry Feed: Impact of Coal Rank, Slurry Loading, and Syngas Cooling Technology. Industrial & Engineering Chemistry Research 2012, 51(36), 11778-11790.
6. Swanson, M. L.; Musich, M. A.; Schmidt, D. D.; Schultz, J. K. Feed System Innovation for Gasification of Locally Economic Alternative Fuels (FIGLEAF); DE-FC26-00NT40904; National Energy Technology Laboratory: 2003.
7. National Energy Technology Laboratory, Development of a High-Pressure Dry Feed Pump for Gasification Systems, Project Fact Sheet, 2008-2012
8. National Energy Technology Laboratory, Evaluation of the Benefits of Advanced Dry Feed Systems for Low Rank Coal, Project No. DE-FE0007902, 2011-2012
9. Paull, P. L.; Schlinger, W. G. Synthesis gas from solid carbonaceous fuel. U.S. Pat. No. 3,976,443 1976.
10. Santhanam, C. J. Method and Apparatus for Transporting Coal as a Coal/Liquid Carbon Dioxide Slurry. U.S. Pat. No. 4,206,610, 1980.
11. Dooher, J.; Marasigan, J.; Goldstein, H. N. In Liquid C02 Slurry (LC02) for Feeding Low Rank Coal (LRC) to Gasifiers, 37th International Technical Conference on Clean Coal and Fuel Systems, Clearwater, Fla. (USA), 2012.
12. Wilks, D. M. M., Steven L. Coal Slurry System. U.S. Pat. No. 4,765,781 1988.
13. Chiang, S.-H.; Klinzing, G. E. Process for removing mineral matter from coal. U.S. Pat. No. 4,613,429, 1986.
14. Westinghouse Electric Corporation, Development of the LICADO coal cleaning process; DOE/PC/79873-T1; 1990; p Medium: ED; Size: Pages: (256 p).
15. Kawatra, K., Coal Desulfurization: High Efficiency Preparation Methods. Taylor & Francis: 2001.
16. Chi, S. M., Interfacial properties and coal cleaning in the LICADO process, PhD Thesis, University of Pittsburgh, 1986.

1. Method for making a slurry of a pulverized solid in liquid or supercritical carbon dioxide comprising:
making a water-pulverized solid slurry at ambient pressure;
pressurizing the water-pulverized solid slurry; and
mixing the pressurized water-pulverized solid slurry with liquid or supercritical CO₂ in a pressurized chamber, to form a CO₂-pulverized solid slurry.

2. The method of claim 1 further including vaporizing excess CO₂ from the CO₂-pulverized solid slurry to concentrate the CO₂-pulverized solid slurry.

3. The method of claim 1 wherein the water-pulverized solid slurry is pressurized in the range of 60-80 bar.

4. The method of claim 2 wherein CO₂ is vaporized to provide a 80% loading.

5. The method of claim 1 further including a slurry skimming to remove substantially all of the CO₂ from the CO₂-pulverized solid slurry.

6. The method of claim 5 wherein the slurry skimming step involves low-grade heat addition.

7. The method of claim 5 wherein the slurry skimming step involves a pressure reduction.
